(19) United States
(12) Patent Application Publication
(10) Pub. No.: US 2001/0003608 A1
(43) Pub. Date: Jun. 14, 2001

(54) COATING COMPOSITIONS AND COATED ARTICLES

(75) Inventors: WARREN G. MANG, HADDONFIELD, NJ (US); KENNETH D. HOBBS, CONSHOHOCKEN, PA (US); CHARLES P. MARINO, PHILADELPHIA, PA (US)

Correspondence Address: DAVID B. RITCHIE, THELEN REID & PRIEST LLP, P.O. BOX 640640, SAN JOSE, CA, 95164-0640, US

(73) Assignee: Warren G. Mang et al

(21) Appl. No.: 09/176,926

(22) Filed: Oct. 22, 1998

Related U.S. Application Data
(60) Provisional application No. 60/062,938, filed on Oct. 22, 1997.

(51) Int. Cl. B32B 27/40; F16L 1/00; B29D 22/00; B65D 1/00

(52) U.S. Cl. 428/36.3; 428/36.91; 428/425.6; 524/501

(57) ABSTRACT

Resilient coatings and articles coated therewith which exhibit abrasion-resistance of at least about 10,000 cycles before failure as measured by test method ARP-1536-A and, when applied to a flexible substrate, capable of withstanding at least about a 50% dimensional compression without permanent deformation or crazing.

This application claims the benefit of U.S. Provisional application Ser. No. 60/062,938, filed on Oct. 22, 1997.

### FIELD OF THE INVENTION

This invention relates to abrasion-resistant coatings and articles coated therewith. More particularly, this invention relates to coating compositions capable of being cured into flexible, abrasion-resistant coatings and articles coated therewith.

Cables, wires, conduits and the like (collectively referred to herein as conduits) are used widely in applications involving mechanical stresses such as those caused by repetitive movements and vibration. Examples of such applications involve the use of conduits in engine compartments, exhaust systems and other areas of automobiles and trucks, as well as other motorized vehicles. In such applications, conduits are often positioned in circuitous paths in close proximity to repetitively moving or vibrating parts. If left exposed to such movements or vibrations, conduits will wear through quickly and the systems of which they are a part will become damaged. When such systems are involved in the operation or safety of a vehicle, it is of critical importance that the conduits of such systems are protected from abrasive failure.

Sleeving is used as a physical barrier to protect conduits from the wear to which they would otherwise be subject. While a variety of materials have been employed in the construction of sleeving for conduits, a material commonly used in automotive applications is fiberglass. This material is selected for its combination of flexibility and thermal stability which are important properties in such applications. Fiberglass, however, exhibits poor abrasion-resistance. It is damaged easily by the same repetitive movements and vibrations which cause damage to the conduits for which it is used. Thus, the protection that fiberglass sleeving affords is limited by the amount of abrasive force it can withstand before failure. This is also true of other materials used in the construction of sleeving.

In order to improve the abrasion-resistance of the aforementioned type of sleeving, it is known in the art to apply abrasion-resistant coatings thereto. The present invention relates to such coatings.

### REPORTED DEVELOPMENTS

Coatings of the aforementioned type are designed to adhere to the exterior surface of sleeving and to impart thereto abrasion-resistant properties. The abrasion-resistance of the coatings known to the art, however, is insufficient for many applications which involve strong or continuous abrasive forces or for applications in which abrasion-resistance is critical to safety. Further, improvements in abrasion-resistance of prior art coatings is achieved at the expense of flexibility. This tradeoff is problematic in applications which require pliant sleeving as the abrasion-resistance of the coating must be compromised.

Examples of coating compositions which are used commercially to form abrasion-resistant coatings of the aforementioned type include those which comprise acrylic and silicone rubber resins. Coatings formed therefrom exhibit abrasive wear through at about 2,500 to 2,800 cycles as measured by test method ARP-1536-A. The abrasion-resistance of such prior art coatings, while appropriate for a variety of applications, is inadequate for applications in which significant abrasive forces are present over extended periods. Other prior art coatings, such as those comprising cross-linked polyurethane resins, provide a greater measure of abrasion-resistance, abrasive wear through at about 28,000 cycles as measured by test method ARP-1536-A, but are essentially inflexible and incapable of any significant deformation without crazing. Examples of polyurethane compositions used to form such coatings are polyurethane latexes sold under the trade names 842-O and LG86-OA by Lyons Coatings, Inc. of Franklin, Mass.

Experience has shown that many types of woven or braided sleeving tend to fray at cut ends. When this occurs, structural integrity is compromised and the useful life of the sleeving is shortened. In the case of fiberglass sleeving, such fraying is accompanied also by the release of glass fibers. This release is particularly troublesome during handling which can cause glass fibers to shed from frayed ends directly onto the hands of workers. Fibers are also released into the air where they find their way onto the exposed skin or into the airways and lungs of workers. Through such contact, glass fibers cause dermatitis, other forms of skin irritation, and respiratory problems.

Attempts have been made to use coatings to control fray and the consequent release of fibers from sleeving. The coatings of the prior art, however, have been unsuccessful in restraining fiber fray at cut ends. As a result, such coatings fail to suppress the release of fibers, particularly glass fibers, onto the hands of workers or into the air.

The present invention relates to the provision of a coating composition which is capable of forming a abrasion-resistant coating that has a combination of improved properties and to coated articles which have a unique combination of properties that make them highly desirable for use in a variety of demanding applications.

### SUMMARY OF THE INVENTION

In accordance with one aspect of the present invention, there are provided coatings which exhibit abrasion-resistance of at least about 10,000 cycles before failure as measured by test method ARP-1536-A and, when applied to a flexible substrate, are able to withstand at least about a 50% dimensional compression of the substrate without permanent deformation or crazing. Such coatings further demonstrate a high degree of resilience, that is, the ability to return to their original shape after a compressive or other load is released.

In preferred embodiments, the coatings of the present invention are capable of withstanding at least about a 70% dimensional compression without permanent deformation or crazing while exhibiting abrasion-resistance of at least about 20,000 cycles, and more preferably at least about 35,000 cycles, before failure.

Another aspect of the present invention constitutes the provision of a coating composition which is capable of forming the aforementioned type coatings. Such composition comprises at least one “abrasion-resistant” resin, preferably a thermosetting resin, and an elastomer. In preferred embodiments, the composition comprises a thermosetting, abrasion-resistant resin, preferably a polyurethane resin, an elastomer, a cross-linking agent and, optionally, a pigment. In those preferred embodiments in which relatively high abrasion-resistance is important, the compositions of the present invention further comprise polyolefin powder, preferably high-density, surface-activated polyolefin powder.

Highly preferred embodiments of the coating compositions of the present invention comprise about 42 to about 52 wt. % thermosetting abrasion-resistant resin, about 42 to about 52 wt. % elastomer, about 1.5 to about 3 wt. % cross-linking agent, and, optionally, about 2 to about 10 wt. % pigment. In those embodiments in which polyolefin powder is also present, such coating compositions preferably comprise about 3 to about 5 wt. % polyolefin powder. Even more preferred embodiments comprise about 44 wt. % of an aqueous dispersion of a polyether-based TMXDI polyurethane sold under the trade name LG86-OA by Lyons Coatings, Inc. of Franklin, Mass. having a solids content of at least about 50%, about 44 wt. % of an aqueous dispersion of a saturated acrylic terpolymer sold under the trademark HyStretch™ Latex V-43 by The B. F. Goodrich Co. of Cleveland, Ohio having a solids content of at least about 50%, about 2.5 wt. % hexamethyoxymethylmelamine, about 4 wt. % carbon black and about 5 wt. % surface-activated high-density polyethylene powder having an average particle size of about 18 microns and a molecular weight of about 100,000.

The compositions of the present invention are preferably adaptable to the formation of flexible, abrasion-resistant coatings on sleeving for conduits, wires and the like. In more preferred embodiments, the sleeving to which the coating composition is applied comprises fiberglass, preferably braided fiberglass. In such embodiments, the coating applied thereto further inhibits fraying at the cut ends thereof and shedding of fibers therefrom. Preferred compositions of the present invention are particularly well-suited to the formation of flexible, abrasion-resistant coatings for fiberglass sleeving for the insulation from mechanical stress and vibration of carbon brush leads, sensor elements, thermocouple wires, and oxygen sensor assemblies in automotive emissions monitoring systems.

The present invention provides the user with numerous advantages. Dramatically superior abrasion-resistance without significant loss of flexibility can be realized by the use of the compositions described herein. By the application of such coating compositions to materials, such as sleeving used for conduits, a superior abrasion-resistant article is provided. Further, the coatings formed from the compositions of the present invention provide significant fray-resistance when applied to fiberglass sleeving as well as sleeving constructed from other fibrous materials. Through the minimization of fiber release during cutting and handling, the potential for skin and lung irritation is markedly reduced.

### DETAILED DESCRIPTION OF THE INVENTION

The compositions of the present invention comprise a combination of least one abrasion-resistant resin, preferably a thermosetting resin, and an elastomer, and are capable of being cured into a coating which exhibits abrasion-resistance of at least about 10,000 cycles before failure as measured by test method ARP-1536-A and, when applied to a flexible substrate, are able to withstand at least about a 50% dimensional compression of the substrate without permanent deformation or crazing.

The abrasion-resistant resin of the compositions of the present invention serves to impart abrasion-resistance to the coating upon being cured. The term “abrasion-resistant resin” means a resin which itself possesses abrasion-resistant properties or a resin which can be converted into a material which has abrasion-resistant properties. Abrasion-resistant resins which are considered within the scope of the present invention are those polymers which, when combined with an elastomer, are capable of being cured into a coating which exhibits abrasion-resistance of at least about 10,000 cycles before failure as measured by test method ARP-1536-A and, when applied to a flexible substrate, is able to withstand at least about a 50% dimensional compression of the substrate without permanent deformation or crazing. Examples of such resins are polyurethanes and fluorocarbon polymers.

Thermosetting resins are preferred for their ability to impart significant abrasion-resistance upon being cured. While most thermosetting resins will cure on their own or upon the application of heat, preferred embodiments of the present invention include a cross-linking agent to promote curing and shorten the time required to effect such curing. Preferred cross-linking agents are discussed below.

In accordance with the preferred embodiments of the present invention, the thermosetting resins of the present invention comprise polyurethanes. Polyurethanes, as a class of organic compounds, are addition polymers generally obtained from the chemical reaction of a diisocyanate and a polyol. Often, part or all of the diisocyanate is first reacted with part of the polyol component to form a low-molecular weight polymeric diisocyanate, known as a prepolymer, that is subsequently chain-extended. This is done to control more precisely the polyurethane formation reaction while eliminating monomeric diisocyanate.

Isocyanates known to the art and used commonly in the formation of polyurethanes include polymeric isocyanates (PMDI), aromatic isocyanates such as toluene diisocyanate (TDI) (such as the 2,4- or 2,6-isomers), 4,4′-methylene bis(phenyl isocyanate) (MDI), 1,4-phenylene diisocyanate, m- and p-xylene diisocyanates (XDI), m-tetra methyl xylylene diisocyanate (TMXDI) or 1,5 naphthalene diisocyanate (NDI), or aliphatic diisocyanates such as isophorone diisocyanate (IPDI), methylenedicyclohexyl diisocyanate, trimethylhexane diisocyanate (TMI) or hexamethylene diisocyanate and its derivatives. Polyols known to the art and used commonly in the formation of polyurethanes include diols such as ethylene glycol, 1,2-propylene glycol, 1,3-propylene glycol, 1,4-butanediol (BDO), 1,5-pentanediol, diethylene glycol, polyester-based polyols such as butanediol-based polyester glycols (like polybutylene adipate glycol), polyethylene adipate or phthalate, or polyether-based polyols such as polyether glycol or polyalkylene oxides. A particularly preferred polyurethane is a polyether-based TMXDI polyurethane sold under the trade name LG86-OA by Lyons Coatings, Inc. of Franklin, Mass.

The elastomer component functions to enhance the flexibility of the coating formed therefrom. This flexibility, in large part, is due to the low glass transition temperatures such elastomers exhibit. While the inclusion of elastomers is important to the flexibility of embodiments of the present invention, it is important that such elastomers are used in amounts which do not impart excessive tack to the resulting coatings. Indeed, it is important to the preferred compositions of the present invention that the relative proportions of thermosetting resin and elastomer are judiciously selected in order to avoid both excess rigidity as well as excess tack in the coatings formed therefrom.

Elastomers which are considered within the scope of the invention are elastomers which, when combined with the abrasion-resistant resin, are capable of forming coatings which exhibit abrasion-resistance of at least about 10,000 cycles before failure as measured by test method ARP-1536-A and, when applied to a flexible substrate, are able to withstand at least about a 50% dimensional compression of the substrate without permanent deformation or crazing. Preferred elastomers for use in the compositions of the present invention are thermosetting elastomers. Examples of elastomers include polyolefin blends, ethylene-propylene copolymers, ethylene-propylene-diene terpolymers, acrylates and the like. A particularly preferred elastomer is the saturated acrylic terpolymer sold under the trademark HyStretch™ Latex V-43 by The B. F. Goodrich Co. of Cleveland, Ohio.

In accordance with preferred embodiments of the present invention, the abrasion-resistant resin and the elastomer are solids which are provided in the form of aqueous dispersions. Such dispersions are capable of being readily mixed to form a coating composition comprising an aqueous dispersion of the mixed solids. Providing the components as a dispersion of solids in an aqueous phase permits homogeneity in mixing thereof as well as ease of application to the substrate to be coated therewith. As aqueous dispersions, however, it is important that the coating compositions have sufficient solids content to enable the composition to form a coating which penetrates into the substrate upon application thereto. Preferably, the solids content of the resin component and the elastomer component is at least about 50%.

In accordance with the present invention, the abrasion-resistant resin and the elastomer components may combined in any proportions which, when cured, are capable of forming coatings which exhibit abrasion-resistance of at least about 10,000 cycles before failure as measured by test method ARP-1536-A and, when applied to a flexible substrate, are able to withstand at least about a 50% dimensional compression of the substrate without permanent deformation or crazing. Particularly preferred compositions comprise approximately equal proportions of the resin and the elastomer.

An important aspect of preferred embodiments of the present invention is the use of cross-linking agents. Such agents are used to promote the cure of thermosetting resins and decrease cure time. The mixture of a thermosetting resin and an elastomer is combined with a sufficient amount of a cross-linking agent to promote cross-linking upon heating. Curing of the thermosetting resin is desirable as it promotes bonding between the coating and the substrate to which the coating is applied, which in turn improves fray resistance at cut ends in applications involving fibrous substrates. Curing also enhances the physical properties, such as abrasion-resistance, of coatings made therefrom. Various cross-linking agents are well known to the art, including, for example, peroxides, polymeric melamines and isocyanates. Preferably, the cross-linking agent comprises a methylolated melamine, and even more preferably, hexamethoxymethylmelamine (HMMM) which is sold under the trademark Cymel® 303 by Cytec Industries, Inc. of West Patterson, N.J.

The amount of cross-linking agent to be used will vary according to the degree of cure desired and the number and nature of the functionalities of the thermosetting resin at which cross-linking reactions can occur. In any event, the amount of cross-linking agent will be selected consistent with effecting a sufficient cure to bring the coating formed therefrom within the scope of the invention as herein described. Preferably, the cross-linking agent comprises about 1 to about 5 wt. %, preferably about 1.5 to about 3 wt. % of the composition.

The compositions of the present invention may be cured by any of the curing methods known to the art. Preferably, curing is effected by the application of heat. Several techniques for applying heat are known and are adaptable for use in accordance with this aspect of the invention. For example, the application of heat can be achieved by means of convection, radiation or by other means.

The temperature range in which curing is effected will be determined by, among other things, the particular constituents comprising the composition, the amount of coating composition applied, the time of exposure, and the degree of cure desired. Similarly, the time period in which curing occurs will depend on the particular constituents comprising the composition, the amount of coating composition applied, the temperature to which the composition is exposed, and the degree of cure desired. The temperature range and cure times considered within the scope of the present invention are those combinations of temperatures and exposure times which are capable of permitting sufficient curing to form a coating which exhibit abrasion-resistance of at least about 10,000 cycles before failure as measured by test method ARP-1536-A and, when applied to a flexible substrate, is able to withstand at least about a 50% dimensional compression of the substrate without permanent deformation or crazing. It is believed that the compositions used most widely will be capable of being cured in an oven set at about 500° F. to about 800° F., preferably about 650° F. to about 750° F., for a period of about 30 to about 90 seconds, preferably about 45 to about 60 seconds.

Pigments are optional constituents which are employed in preferred embodiments of the present invention to provide color to the resulting coatings. Pigmented coatings are desirable not only for aesthetic reasons, but also as a means of color-coding various grades and sizes of coated articles for ease of use. Examples of pigments which may be used in the practice of the present invention include carbon black and metal oxides, for example, ferric oxide, titanium dioxide and the like. A particularly preferred pigment is carbon black sold under the trademark Harshaw W-7012 by Engelhard Corporation. In those embodiments in which pigments are used, the pigments comprise about 2 to about 10 wt. % of the composition, preferably about 4 wt. %.

Higher degrees of abrasion-resistance may be realized by the addition to the compositions of the present invention of polyolefin powder, preferably high-density, surface-activated polyolefin powder. As used herein, a high-density polyolefin powder refers to a polyolefin powder which has a density of at least about 0.96 grams per cubic centimeter. The polyolefin powders considered within the scope of the present invention are those polyolefin powders which are capable of forming coatings which exhibit abrasion-resistance of at least about 30,000 cycles before failure as measured by test method ARP-1536-A and, when applied to a flexible substrate, are able to withstand at least about a 50% dimensional compression of the substrate without permanent deformation or crazing. Particularly preferred polyolefin powders are high-density, surface-activated polyethylene (HDPE) and polytetrafluoroethylene (PTFE). Species of such powders are known and are available commercially.

Surface activation, whether achieved by means of physical or chemical treatment, is important in those preferred embodiments of the composition which are in the form of aqueous dispersions. The activated surface of the polyolefin powder disperses more readily throughout the composition providing a more homogenous mixture and a more even distribution in the coating formed therefrom.

In those preferred embodiments in which polyolefin powders are used, the amount of polyolefin used will vary according to, among other things, the degree of additional abrasion-resistance desired. In any event, however, the amount of polyolefin powder will be selected consistent with effecting a sufficient degree of abrasion-resistance to bring the coating formed therefrom within the scope of the invention as herein described. Preferably, the polyolefin powder component comprises about 1 to about 10 wt. % of the composition, preferably about 3 to about 5 wt. %.

Examples of polyolefin powders that can be used are those having an average particle size of about 10 to about 35 microns, preferably from about 18 to about 25 microns, and even more preferably, about 18 microns. Because the coatings formed by the compositions of the present invention form a film on the surface of the substrate to which they are applied, the particle size of the polyolefin powder affects the surface profile of the coated article. More particularly, as the particle size of the polyolefin powder is increased, the coatings containing such powders are rougher in both appearance and feel, and exhibit relatively higher coefficients of friction. The use of polyolefin powders within the preferred particle sizes set forth above permits the formation of relatively smooth coatings having a low coefficients of friction.

In addition to exhibiting a combination of abrasion-resistance and flexibility to the extent set forth above, the coatings formed from the compositions of the present invention demonstrate superior resilience. Resilience is a measure of the ability of a material to return to its original shape after an applied force is released. A complete return to the original shape would be considered 100% resilience. When preferred coating compositions are applied to materials which are themselves flexible and which are deformed from their original shape, such as by compression, the resilience of the coatings formed thereon tend to return the material to their original shape after the applied force is released. Accordingly, preferred coatings formed from compositions of the present invention demonstrate resilience close to or at 100%.

Articles of the present invention comprise a substrate and having adhered thereto a flexible coating which is capable of being compressed at least about 50%, preferably at least about 70%, without permanent deformation or crazing and of withstanding at least about 10,000 cycles, preferably at least about 20,000 cycles and more preferably at least about 35,000 cycles, before failure as measured by test method ARP-1536-A. Although any substrate which is capable of being coated and of having the coating composition adhered thereto can be used, it is believed that the most widely used substrate will be a sleeving which is flexible and preferably constructed from fibrous materials such as fiberglass.

Fiberglass sleeving is constructed in a number of ways all of which are well known in the art. These construction methods include circular knit, braid and a hybrid of these methods known as knit braid. All of these construction methods, as well as other methods, produce fiberglass sleeving considered to be within the practice of the present invention. Braiding, however, is particularly preferred as it produces a thin profile sleeving with enhanced structural stability less apt than knitted forms of fiberglass to unravel when cut.

Fiberglass sleeving constructed by any of the methods described above, as well as other methods, tends to fray at cut ends. Accordingly, preferred articles of the present invention are coated with the compositions of the present invention so that the coating bonds to and penetrates into the substrate. In those embodiments which employ fiberglass sleeving, the coating forms a bond with and penetrates into the glass fibers. While the precise bonding mechanism is not known, it is believed to involve the creation of a series of hydrogen bonds between polar functionalities in the coating and in the glass fibers. It is the formation of such bonds which serves to minimize fraying of the fiberglass at cut ends thereof.

### EXAMPLES

The following examples are illustrative of the practice of the present invention. Example 1 describes the preparation of a coating composition within the scope of the present invention and the application of the composition to fiberglass sleevings to form articles within the scope of the present invention.

### EXAMPLE 1

Under ambient temperature and pressure conditions, 2.5 gallons of an aqueous dispersion of a polyether-based TMXDI polyurethane sold under the trade name LG86-OA by Lyons Coatings, Inc. of Franklin, Mass., having a solids content of about 50%, were charged to a 5 gallon mixing vessel. Under constant gentle stirring, 2.5 gallons of an aqueous dispersion of a saturated acrylic terpolymer sold under the trademark HyStretch™ Latex V-43 by The B. F. Goodrich Co. of Cleveland, Ohio, having a solids content of about 50.5%, were added. This mixture was homogenized by continuous gentle stirring for about one hour. Five hundred grams of cross-linking agent, hexamethyoxy-methylmelamine (HMMM), sold under the trademark CYMEL® 303 by Cytec, Inc., were added, and the mixture was homogenized by continuous gentle stirring for 20 to 30 minutes. Eight hundred grams of carbon black, sold under the trademark Harshaw W-7012 by Engelhard Corporation were added and the mixture was homogenized by continuous gentle stirring for 20 to 30 minutes.

The coating composition was applied at room temperature to a continuous length of braided fiberglass sleeving having an inside diameter of 0.276 in. and a wall thickness of about 13 mils. The coating composition was then cured by heating the coated fiberglass sleeving in a curing oven set at 750° F. for a period of about 45 seconds. The coated sleeving was then cooled by means of a blower, and collected on a spool or take-up reel.

### EXAMPLE 2

A coating composition was made in accordance with Example 1. To the coating composition was added 1 kilogram of surface-activated, high-density polyethylene powder, sold under the trademark VISTAMER® HD by Composite Particles, Inc., having an average particle size of about 18 microns and a molecular weight of about 100,000.

The coating composition of Example 2 was applied at room temperature to a continuous length of the same size braided fiberglass sleeving used in Example 1 and cured in accordance with the procedures of Example 1.

The abrasion-resistance of four samples of each of the coated articles of the examples were tested in accordance with test method ARP-1536-A. This method was conducted at ambient room temperatures and involved the application of a repetitive abrasive force to the material being tested until wear-through. More specifically, this test method requires a stainless steel mandrel to be inserted into the coated fiberglass sleeving and involves immobilizing both the mandrel and sleeving. The fiberglass sleeving was then subjected to repetitive stress by an abrasive element comprising a 0.5 inch diameter precision ground drill rod having a Rockwell “C” hardness of 60-64 and a surface finish roughness average of 16 μin. The abrasive element was oriented perpendicular to the long axis of the sleeving and placed under a load of 2.5 pounds. The abrasive force was applied at a rate of 200±10 cycles per minute through a total stroke of 3 inches moving longitudinally along the sleeving. The stainless steel mandrel and the abrasive element were connected to an appropriate voltage source in series with a monitor-indicator to stop the test when the abrasive element wore through the sleeving.

Four samples of the coated fiberglass sleevings of Examples 1 and 2 were tested for abrasion-resistance in accordance with the test method specified above. The number of cycles to wear-through for each of these coated fiberglass sleevings are set forth in Table 1 below.

TABLE 1

| Ex.1 Sleeving | A | B | C | D |
|---|---|---|---|---|
| | 29,651 | 29,894 | 20,219 | 20,377 |
| Ex.2 Sleeving | E | F | G | H |
| | 38,627 | 42,812 | 37,062 | 43,478 |

The coatings of the coated fiberglass sleevings of Examples 1 and 2, as well as other preferred coatings of the present invention applied to fibrous substrates, have the additional property of minimizing fray at cut ends thereof. Such coatings are further able to be used in environments having a continuous operating temperatures of up to about 180° C. and for short durations in environments having temperatures of up to about 200° C. This advantageous combination of properties found in such coatings, together with the properties set forth above, makes such coatings particularly well adapted for articles used in connection with carbon brush leads, sensor elements, thermocouple wires and oxygen sensor assemblies in automotive emissions monitoring systems.

### COMPARATIVE EXAMPLES 1 AND 2

The following comparative examples are illustrative of coating compositions and coated articles of the prior art. Comparative Examples 1 and 2 describe certain prior art coating compositions applied to fiberglass sleevings and the abrasion characteristics thereof.

Two samples of fiberglass sleeving of the size used in Examples 1 and 2 were each coated with a prior art coating composition. One prior art coating composition is acrylic-based and the other is a silicone rubber composition. The abrasion-resistance of the two coated fiberglass sleevings were then tested in accordance with the test method set forth above. The number of cycles to wear-through for each of the coated fiberglass sleevings is set forth in Table 2 below.

TABLE 2

| | |
|---|---|
| Ex. C-1 Sleeving | 2,800 Cycles (approx.) |
| Ex. C-2 Sleeving | 2,500 Cycles (approx.) |

Comparisons of the performances of coated fiberglass sleevings of the present invention, as shown in Table 1, with the acrylic and silicone rubber coated fiberglass sleevings of the prior art, shown in Table 2, demonstrate the marked superiority in abrasion-resistance of the coated fiberglass sleevings of the present invention. Under the testing protocol described, the coated fiberglass sleevings of the present invention demonstrated from about 9 to over 16 times the abrasion-resistance of the coated fiberglass sleevings of the prior art.

The flexibility and compressive properties of coated sleevings of the present invention and of the prior art were also evaluated. Flexibility was tested in accordance with a protocol which involves placing a ten-inch length of coated fiberglass sleeving onto a steel mandrel. The sleeving was then compressed axially by hand along the length of the mandrel to its limit of compressibility. The length of the compressed sleeving was then measured to determine the percent compression. (A sleeving which can be compressed to half its original length would have a 50% compression whereas a product capable of being compressed to 90% of its original length would have a 10% compression.) The compressive load was then released and the length of the sleeving was measured after one minute to determine resilience.

Samples of the coated fiberglass sleevings of Examples 1 and 2 and Comparative Examples 1 and 2 were tested for flexibility in accordance with the test method specified above. The percents of compression and resilience for the coated fiberglass sleevings are set forth in Table 3 below.

TABLE 3

| Coated Sleeving | % Compression | Resilience (%) |
|---|---|---|
| Example 1 | 70% | 100% |
| Example 2 | 70% | 100% |
| Example C-1 | 60% | 80% |
| Example C-2 | 60% | 100% |

Comparisons of the performances of the coated fiberglass sleevings of the present invention with those coated fiberglass sleevings of prior art demonstrate the superiority in flexibility of the coated fiberglass sleevings of the present invention. Under the testing protocol described, the coated fiberglass sleevings of the present invention were capable of about 10 percent more compression and up to about 20 percent greater resilience.

In summary, it can be said that the compositions of the present invention demonstrate superior abrasion-resistance and, when applied to flexible substrates such as fiberglass sleeving, greater flexibility and resilience.

We claim:

1. A coating composition capable of being cured into a coating which is capable of being axially compressed at least 50% without permanent deformation and of withstanding at least about 10,000 cycles before failure as measured by test method ARP-1536-A and which comprises at least one abrasion-resistant resin and an elastomer.

2. The coating composition of claim 1 wherein the coating is capable of being compressed at least 70% without permanent deformation or crazing and of withstanding at least about 20,000 cycles before failure as measured by test method ARP-1536-A.

3. The coating composition of claim 2 wherein the coating is capable of withstanding at least about 35,000 cycles before failure as measured by test method ARP-1536-A.

4. The coating composition of claim 1 wherein the composition comprises about 42 to about 52 wt. % thermosetting abrasion-resistant resin, about 42 to about 52 wt. % elastomer, about 1.5 to about 3 wt. % cross-linking agent and, optionally, about 2 to about 10 wt. % pigment.

5. The coating composition of claim 4 wherein the coating further comprises about 3 to about 5 wt. % polyolefin powder.

6. The coating composition of claim 5 wherein the polyolefin powder has an average particle size of about 10 to about 35 microns.

7. A coating composition comprising about 44 wt. % of an aqueous dispersion of a polyether-based TMXDI polyurethane sold under the trade name LG86-OA by Lyons Coatings, Inc. of Franklin, Mass. having a solids content of at least about 50%, about 44 wt. % of an aqueous dispersion of a saturated acrylic terpolymer sold under the trademark HyStretch™ Latex V-43 by The B. F. Goodrich Co. of Cleveland, Ohio having a solids content of at least about 50%, about 2.5 wt. % hexamethyoxymethylmelamine, about 4 wt. % carbon black and, optionally about 5 wt. % surface-activated high-density polyethylene powder having an average particle size of about 18 microns and a molecular weight of about 100,000.

8. A coated article comprising a substrate and adhered thereto a flexible coating which is capable of being compressed at least 50% without permanent deformation or crazing and of withstanding at least about 10,000 cycles before failure as measured by test method ARP-1536-A.

9. The coated article of claim 8 wherein the coating is capable of being compressed at least 70% without permanent deformation or crazing and of withstanding at least about 20,000 cycles before failure as measured by test method ARP-1536-A.

10. The coated article of claim 9 wherein the coating is capable of withstanding at least about 35,000 cycles before failure as measured by test method ARP-1536-A.

11. The coated article of claim 9 wherein the coating comprises about 42 to about 52 wt. % cross-linked, thermosetting, abrasion-resistant resin, about 42 to about 52 wt. % elastomer, about 1.5 to about 3 wt. % cross-linking agent and, optionally, about 2 to about 10 wt. % pigment.

12. The coated article of claim 11 wherein the coating further comprises about 3 to about 5 wt. % polyolefin powder.

13. The coated article of claim 12 wherein said substrate comprises a braided fiberglass sleeving and said coating comprises a cross-linked, thermosetting, abrasion-resistant resin, an elastomer, a cross-linking agent and, optionally, a pigment.

14. The coated article of claim 13 wherein the coating is capable of being compressed at least 70% without permanent deformation or crazing and of withstanding at least about 20,000 cycles before failure as measured by test method ARP-1536-A.

15. The coated article of claim 14 wherein the coating is capable of withstanding at least about 35,000 cycles before failure as measured by test method ARP-1536-A.

16. The coated article of claim 13 wherein the coating comprises about 42 to about 52 wt. % cross-linked thermosetting abrasion-resistant resin, about 42 to about 52 wt. % elastomer, about 1.5 to about 3 wt. % cross-linking agent and, optionally, about 2 to about 10 wt. % pigment.

17. The coated article of claim 13 wherein the coating further comprises a polyolefin powder.

18. The coated article of claim 16 wherein the coating further comprises about 3 to about 5 wt. % polyolefin powder.

19. The coated article of claim 17 wherein the polyolefin powder has an average particle size of about 10 to about 35 microns.

20. The coated article of claim 13 wherein the coating comprises about 44 wt. % cross-linked polyether-based TMXDI polyurethane sold under the trade name LG86-OA by Lyons Coatings, Inc. of Franklin, Mass., about 44 wt. % saturated acrylic terpolymer sold under the trademark HyStretch™ Latex V-43 by The B. F. Goodrich Co. of Cleveland, Ohio, about 2.5 wt. % hexamethoxymethylmelamine, about 4 wt. % carbon black and, optionally, about 5 wt. % surface activated high-density polyethylene powder having an average particle size of about 18 microns and a molecular weight of about 100,000.
